(19) United States
(12) Patent Application Publication
(10) Pub. No.: US 2010/0142828 A1
(43) Pub. Date: Jun. 10, 2010

(54) IMAGE MATCHING APPARATUS AND METHOD

(75) Inventors: Ji Ho Chang, Daejeon (KR); Seung Min Choi, Daejeon (KR); Jae Il Cho, Daejeon (KR); Dae Hwan Hwang, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/474,848

(22) Filed: May 29, 2009

(30) Foreign Application Priority Data
Dec. 10, 2008 (KR) 10-2008-0125425

(51) Int. Cl. G06K 9/62

(52) U.S. Cl. 382/209

(57) ABSTRACT

Provided are an image matching apparatus and method, and the image matching apparatus includes a determining unit determining whether a node, in which a first pixel of a left image of a subject and a second pixel of a right image of the subject corresponding to the first pixel are calculated, is a matchable region, and an operating unit calculating a disparity value by using the brightness information of a left window composed of the first pixel corresponding to the node and peripheral pixels surrounding the first pixel and the brightness information of a right window composed of the second pixel corresponding to the node and peripheral pixels surrounding the second pixel, when the node is the matchable region as a result of the determination.

### CROSS-REFERENCE TO RELATED APPLICATIONS

This application claims priority under 35 U.S.C. §119 to Korean Patent Application No. 10-2008-125425, filed on Dec. 10, 2008, the disclosure of which is incorporated herein by reference in its entirety.

### TECHNICAL FIELD

The following description relates to an image matching apparatus and method, and in particular, to an image matching apparatus and method, which apply Sum of Absolute Difference (SAD) and Census Transform (CT) to a stereo matching algorithm using a dynamic programming approach.

### BACKGROUND

A stereo image matching technology is a technology for obtaining a Three-Dimensional (3D) image from a stereo image, and is used to obtain a 3D stereo image from a plurality of Two-Dimensional (2D) images. Herein, the stereo image is referred to as a plurality of paired 2D images, which photographed the same subject by two cameras disposed in different positions on the same straight line.

That is, stereo image matching can be a process of calculating a distance to a subject by extracting the disparity of a stereo image using the difference of view angle of the stereo image.

A stereo image matching technology using a related art dynamic programming approach replaces stereo images obtained from two stereo cameras (the left camera and the right camera) by an image disposed on the center line of two cameras by row unit, thereby acquiring a 3D stereo image. However, the related art dynamic programming approach independently processes each row and does not consider the correlation with a above row or a below row upon process of each row, and thus can cause a row-striped noise.

Naturally, the occurrence of a striped noise can be solved by accurately performing the calibration of each camera. However, it is actually difficult to accurately calibrate a camera, and there still exists the measurement error between each camera although the calibration of the each camera is accurately performed. Accordingly, it is difficult to completely solve the striped noise.

Moreover, since the related art dynamic programming approach is designed on the assumption of that the brightness of the left image is in accord with that of the right image (accurately corresponding pixel), an error can occur in image matching when light brightness on the left camera differs from light brightness on the right camera (for example, when strong light is inputted on only one of the left and right cameras). Furthermore, since the related art dynamic programming approach processes each pixel of a current node by using a value transferred from a node before a current node and transfers the process result to a successive node, it can also exert influence on the process of a pixel peripheral to a pixel where an error has occurred.

Moreover, the related art dynamic programming approach performs stereo image matching by comparing the process result of each pixel with a critical constant. However, since the related art dynamic programming approach has set the critical constant without considering brightness of external lighting and disposition of an object, it can further increase an error. To prevent this, a user must manually set the critical constant in consideration of the change of peripheral environments.

### SUMMARY

Accordingly, the present disclosure provides an image matching apparatus and method, which can calculate a disparity value by applying SAD and CT to a stereo matching algorithm using a dynamic programming approach.

The present disclosure also provides an image matching apparatus and method, which can calculate a disparity value with consideration of peripheral pixels surrounding each node upon matching of the each node.

In one general aspect, there is provided an image matching apparatus, including: a determining unit determining whether a node, in which a first pixel of a left image of a subject and a second pixel of a right image of the subject corresponding to the first pixel are calculated, is a matchable region; and an operating unit calculating a disparity value by using the brightness information of a left window composed of the first pixel corresponding to the node and peripheral pixels surrounding the first pixel and the brightness information of a right window composed of the second pixel corresponding to the node and peripheral pixels surrounding the second pixel, when the node is the matchable region as a result of the determination.

In another general aspect, there is provided an image matching apparatus, including: a unit processing unit performing Sum of Absolute Difference (SAD) and Received Mean Census Transform (RMCT) on brightness information of left and right images to calculate an energy value of each node in an synthesis image of the left and right images; a multi-processing unit calculating a matching value of a stereo image per each line by using the energy value of the each node; and a rear processing unit calculating a disparity value of the stereo image by using the matching value.

According to another embodiment, there is provided an image matching method, including: determining whether a corresponding node, in which a first pixel of a left image of a subject and a second pixel of a right image of the subject corresponding to the first pixel are calculated, is a matchable region; and calculating an energy value of a corresponding node by using the brightness information of a left window composed of the first pixel corresponding to a node and peripheral pixels surrounding the first pixel and the brightness information of a right window composed of the second pixel corresponding to the node and peripheral pixels surrounding the second pixel, when the first and second pixels are the matchable region as a result of the determination.

### BRIEF DESCRIPTION OF THE DRAWINGS

FIG. 1 is a block diagram of a system to which an image matching apparatus;

FIG. 2 is an exemplary diagram illustrating an exemplary lattice structure of each pixel of a stereo image;

FIG. 3 is a block diagram functionally illustrating an exemplary multi processing unit of the image matching apparatus;

FIG. 4 is a block diagram of an exemplary image matching apparatus;

FIGS. 5 to 8 are block diagrams of an exemplary image matching apparatus;

FIG. 9 is a flow chart illustrating an exemplary image matching method.

### DETAILED DESCRIPTION OF EMBODIMENTS

Hereinafter, specific embodiments will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

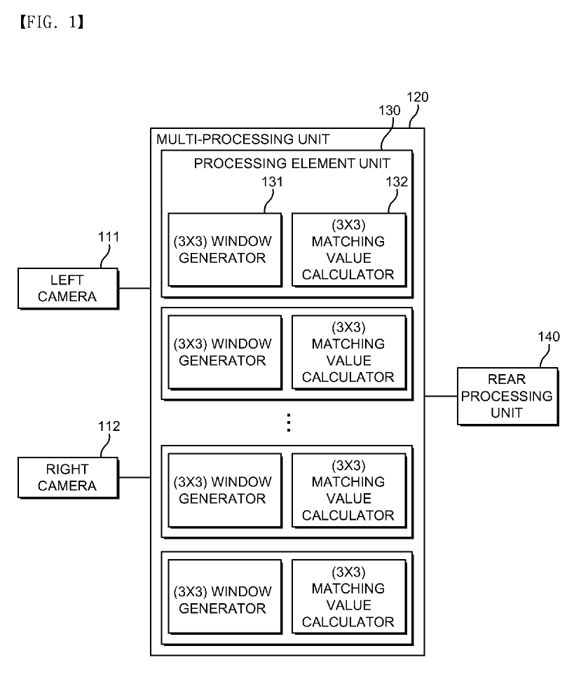

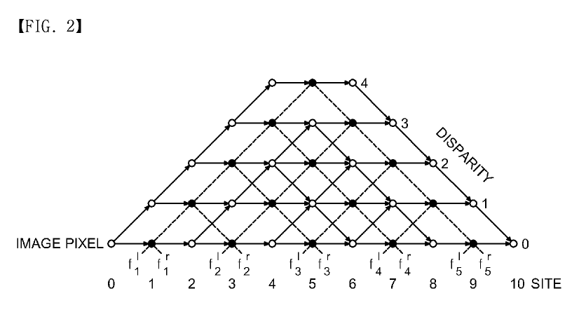

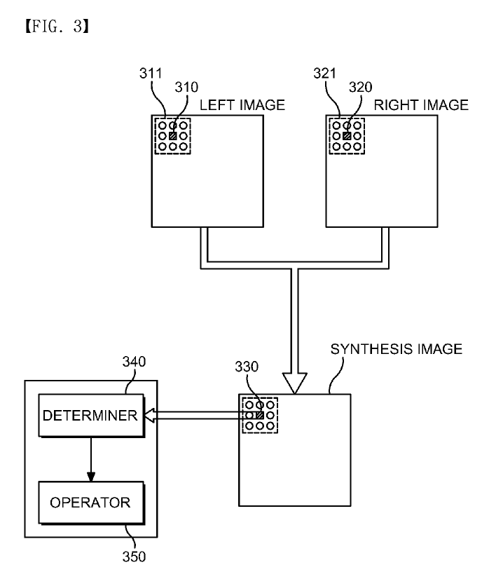

FIG. 1 is a block diagram of a system to which an image matching apparatus according to an embodiment of the present invention is applied. FIG. 2 is an exemplary diagram illustrating the lattice structure of each pixel of a stereo image according to an embodiment of the present invention. FIG. 3 is a block diagram functionally illustrating the multi processing unit of the image matching apparatus according to an embodiment of the present invention.

Referring to FIG. 1, the system, to which the image matching apparatus according to an embodiment of the present invention is applied, includes a left camera 111, a right camera 112, a multi-processing unit 120, at least one processing element unit 130, and a rear processing unit 140.

The left camera 111 is disposed in the left portion of a device including it. The left camera 111 photographs a left image as viewed with the left eye of a user, and transfers the photographed left image to the multi-processing unit 120.

The right camera 112 is disposed in the right portion of a device including the same. The right camera 112 photographs a right image as viewed with the right eye of a user, and transfers the photographed right image to the multi-processing unit 120.

The multi processing unit 120 transfers the left image obtained from the left camera 111 and the right image obtained from the right camera 112 to the processing element unit 130, and processes the left and right images per each line to operate a disparity value corresponding to the processed line.

The number of the processing element unit 130, which is included in the image matching apparatus, is proportional to the number of maximum disparity values to be calculated. The processing element unit 130 includes a window generator 121 and a matching value calculator 122.

The window generator 121 generates a left window and a right window by using image information transferred from the multi-processing unit 120, and transfers the generated left and right windows to the matching value calculator 122.

The matching value calculator 122 receives the left window and the right window, performs SAD and Received Mean Census Transform (RMCT) on the left and right windows, and calculates a matching value. The matching value calculator 122 accumulates an energy value accumulated up to a preceding step or the matching value of above and below lines to the energy value of a corresponding step.

The rear processing unit 140 moves into the horizontal axis through the respective processing element units 130, tracks the accumulated energy value in reverse to thereby operate a disparity value.

At this point, the disparity value has between 0 and less than a maximum disparity, and is changed into between 0 and less than 255 so that it can be outputted as an image having the same size as that of an image input to a user system (not shown). Furthermore, the disparity value can be applied to all sorts of processes using it.

Hereinafter, before the description of the multi-processing unit 120, the following description will be made on the lattice structure of a stereo image for interpreting the disparity of each pixel (hereinafter, referred to as node) with reference to FIG. 2.

In FIG. 2, the lattice structure of each node according to an embodiment of the present invention conceptually illustrates that the each node for an input image is configured per each line. In a case where hardware is actually implemented, only nodes corresponding to portions represented in squares of FIG. 2 are configured and are moved into the X axis by using an input clock (clk), and only an operation result of a matching value for the each node is stored. Herein, the X axis is a sum of the number of the horizontal pixels of input left and right images, and may be the X axis of a stereo image. The Y axis (disparity axis) is that the processing element units equal to the number of the maximum disparity are lengthwise stacked, and is configured with the disparity axis being the Z axis of a final stereo result image.

In FIG. 2, a matchable region is illustrated as a black circle, and an unmatchable region (occlusion region) is illustrated as a white circle. At this point, the matchable region may be that a sum of the order of the site axis and the order of the disparity axis is an odd number, and the unmatchable region may be that a sum of the order of the site axis and the order of the disparity axis is an even number.

The maximum value of the site axis may be a sum of the number of the horizontal pixels of the left image or the right image, or may be two times the number of the horizontal pixels. Since FIG. 2 illustrates only a line of an image, although not shown in FIG. 2, the maximum value of a line axis in a result image may be the number of the vertical pixels of the left or right image. Furthermore, the maximum value of the disparity axis may vary according to the setting of the image matching apparatus. In the image matching apparatus, when bits allotted to the disparity axis are 8 bits, for example, the maximum value of the disparity axis may be 2⁸ (64), which is the maximum disparity signified in the stereo image.

Referring to FIG. 3, the multi-processing unit 120 calculates the disparity value of a stereo image and matches the stereo image by using the brightness information of the left and right images of a subject. The multi-processing unit 120 includes a determiner 340 and an operator 350.

The determiner 340 determines whether a first pixel 310 of the left image of the subject and a second pixel 320 of the right image of the subject corresponding to the first pixel 310 are a matchable region or an unmatchable region.

When the first and second pixels 310 and 320 are the matchable region as a result of the determination, the operator 350 calculates the disparity value of the first and second pixels 310 and 320 by using the brightness information of a left window 311 composed of the first pixel 310 and peripheral pixels surrounding the first pixel 310, the brightness information of a right window 321 composed of the second pixel 320 and peripheral pixels surrounding the second pixel 320 and information changed into RMCT. Alternatively, when the first and second pixels 310 and 320 are the unmatchable region as a result of the determination, the operator 350 receives an energy value from the above/below node of the disparity axis of a current node in a preceding site, receives a matching value from an above/below node being a matchable region, and calculates the disparity value of the first and second pixels 310 and 320.

In this way, since the system to which the image matching apparatus according to an embodiment of the present invention is applied uses the brightness information of pixels peripheral to each node for calculating a disparity value, it can prevent a striped noise and is robust to the change of peripheral lighting.

FIG. 3 respectively illustrates the left and right windows in 3×3 matrix type about the first and second pixels 310 and 320 as an example, but the present invention is not limited to this embodiment. As another example, the left and right windows may have m×n matrix type, and the left and right windows may be any type of windows.

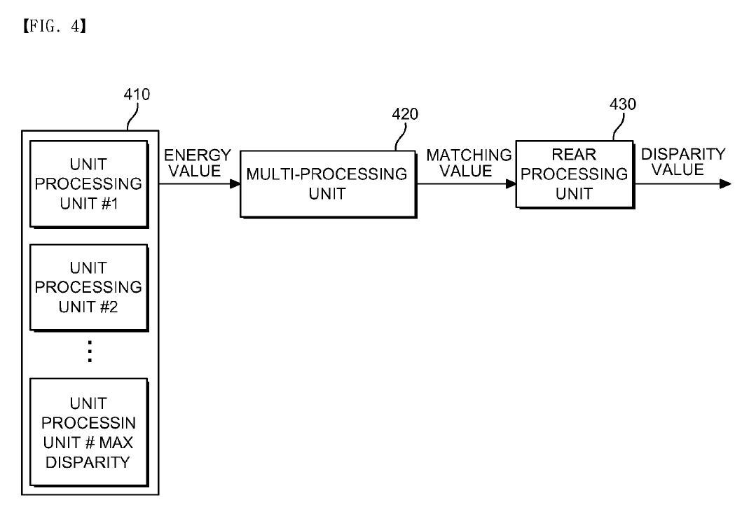

Hereinafter, the specific configuration and function of the image matching apparatus according to an embodiment of the present invention will be described in detail with reference to FIGS. 4 to 8. For convenience, the following description will be made with emphasis on the configuration and function of the multi-processing unit 120 of FIG. 1.

FIG. 4 is a block diagram of the image matching apparatus according to an embodiment of the present invention.

Referring to FIG. 4, the image matching apparatus according to an embodiment of the present invention includes a unit processing unit 410, a multi-processing unit 420, and a rear processing unit 430.

The image matching apparatus at least includes the unit processing unit 410 equal to the disparity number of disparity axis. The unit processing unit 410 determines whether a corresponding node corresponding to the first pixel 310 or the second pixel 320 is a matchable region or an unmatchable region, and calculates the energy value of the corresponding node in respective manners according to a result of the determination.

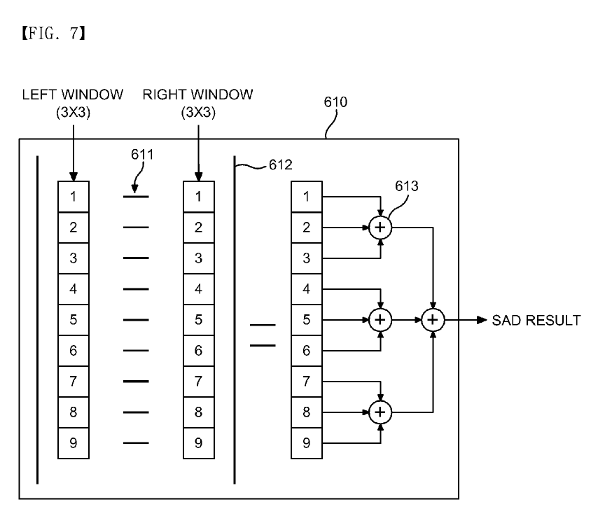

Specifically, when the corresponding node is the matchable region as a result of the determination, the unit processing unit 410 configures the left window composed of the first pixel 310 of the left image and peripheral pixels surrounding the first pixel 310, and configures the right window composed of the second pixel 320 corresponding to the first pixel 310 and peripheral pixels surrounding the second pixel 320 in the right image. The unit processing unit 410 performs SAD and RMCT on the brightness information of the left window and the brightness information of the right window, and adds the SAD and RMCT result and a calculated energy value of a preceding node, thereby calculating the energy value of the corresponding node. At this point, the SAD and RMCT of the unit processing unit 410 will be described below with reference to FIGS. 6 to 8.

Alternatively, when the corresponding node is the unmatchable region as a result of the determination, the unit processing unit 410 selects a small energy value among the accumulated energy values of the above and below nodes of the corresponding node, and calculates an energy value of the corresponding node by using the energy values of the above and below nodes of the corresponding node. Herein, the above and below nodes of the corresponding node may be selected about a site axis being the row of each image and a disparity axis being the depth axis of a subject. At this point, a node of a preceding disparity order of the corresponding node and a node of a succeeding disparity order of the corresponding node may be selected on a disparity axis being the same site axis.

The multi-processing unit 420 stores energy values of a corresponding node, which are transferred from the unit processing unit 410, in a memory to thereby store all energy values of the corresponding line.

The rear processing unit 430 receives matching values by line and tracks only a small portion of an energy value in reverse. At this point, the rear processing unit 430 calculates and outputs the final disparity value corresponding to a line while performing the tracking.

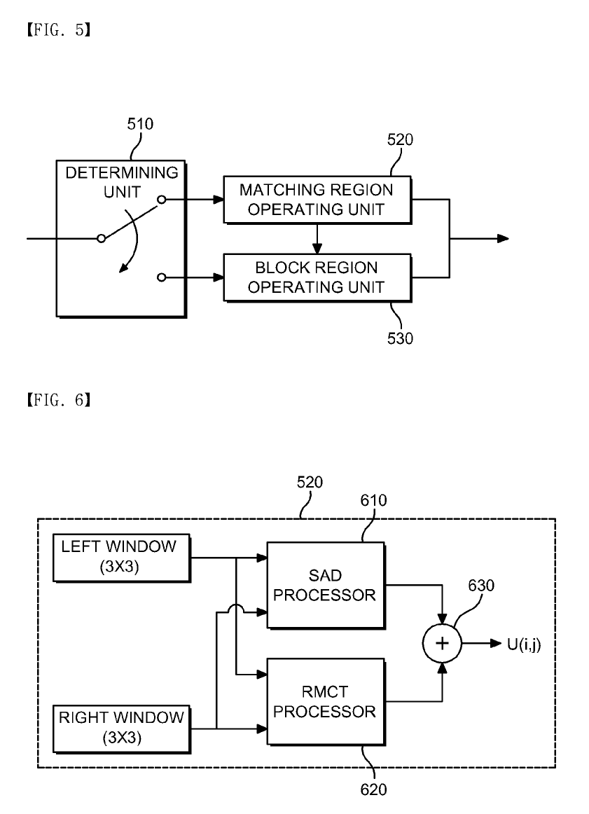

Hereinafter, an image matching apparatus according to another embodiment of the present invention will be described with reference to FIGS. 5 to 8. FIGS. 5 to 8 are block diagrams of the image matching apparatus according to another embodiment of the present invention.

Referring to FIG. 5, the image matching apparatus according to another embodiment of the present invention includes a determining unit 510, a matching region operating unit 520, and a block region operating unit 530.

The determining unit 510 adds an order of the site axis of a corresponding node and an order of the disparity axis of the corresponding node, and transfers an input to the matching region operating unit 520 or the block region operating unit 530 according to the addition result. Herein, an input of the determining unit 510 may be the coordinates of the first pixel 310 of the left image, an order of a current unit processing unit among the unit processing units 410 and the coordinates of the second pixel 320.

When a corresponding node is a matchable region, the matching region operating unit 520 receives the output of the determining unit 510. At this point, as illustrated in FIG. 6, the matching region operating unit 520 respectively performs SAD and RMCT on the left window and the right window, and adds the SAD and RMCT results to operate an energy value of a corresponding node. The detailed configuration of the matching region operating unit 520 will be described below with reference to FIGS. 6 to 8.

When the corresponding node is an unmatchable region, the block region operating unit 530 receives the output of the determining unit 510. The block region operating unit 530 includes a comparator (not shown). Specifically, the comparator of the block region operating unit 530 selects a small value among the energy values of above and below nodes in a preceding site of the corresponding node being the unmatchable region, and the block region operating unit 530 calculates and outputs the energy value of the corresponding node by performing a certain operation on the matching value of the above and below nodes of a current site. The block region operating unit 530 stores the energy value of the corresponding node and the progress direction from a preceding site node to the corresponding node in the memory (not shown) of the multi-processing unit 420.

At this point, the certain operation may variously be applied according to the simulation result of the image matching apparatus. For example, the certain operation may be an addition operation that adds the accumulated value of the preceding calculated energy values of a node to a stored value, a subtraction operation on the accumulated value and the stored value, the four arithmetical operations with a constant.

The following description will be made on the configuration of the matching region operating unit 520 including a SAD processor 610, a RMCT processor 620 and an adder 630 with reference to FIGS. 6 to 8.

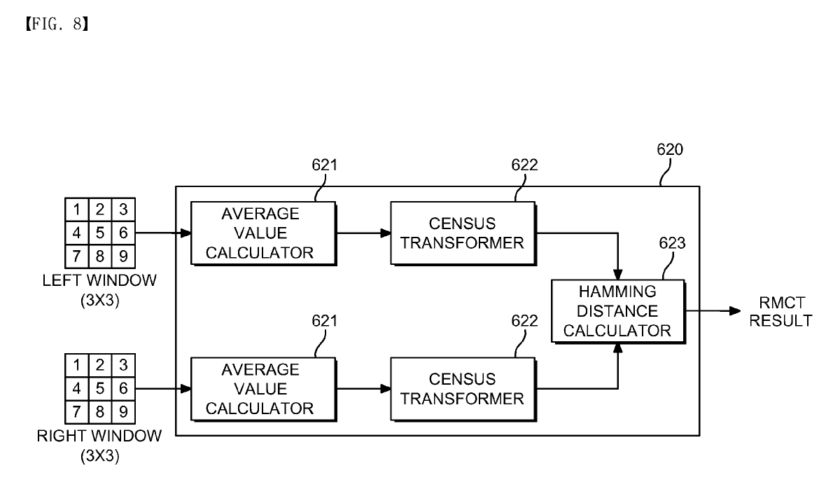

As illustrated in FIG. 7, the SAD processor 610 subtracts the brightness information of the right window from the brightness information of the left window per each pixel, calculates the absolute values of the subtraction results, and adds all the calculated absolute results. The SAD processor 610 includes at least one subtractor 611 subtracting the brightness information of the respective nodes of the right window corresponding to the respective nodes of the left window from the respective nodes of the left window, an absolute value operator 612 calculating the absolute values of the subtraction results, and at least one adder 613 adding all the absolute values.

Referring to FIG. 8, the RMCT processor 620 respectively calculates the average value of the brightness information of the left window and the average value of the brightness information of the right window, performs CT on the calculated average values, and outputs a corresponding distance of the CT results of windows which correspond to each other. The RMCT processor 620 includes an average value calculator 621, a census transformer 622, and a hamming distance calculator 623.

The average value calculator 621 respectively calculates the average values of the brightness information of the left and right windows which are configured about a corresponding node.

The census transformer 622 respectively performs CT on the average value of the brightness information (Y) of the left window and the average value of the brightness information (Y) of the right window. Specifically, the census transformer 622 compares whether the average value of the brightness information of the respective pixels of the left window is greater than an addition value of a predetermined value added to the average value of the brightness information of the left window about the left window. When the average value is greater than the addition value as a result of the comparison, the census transformer 622 assigns 1 else assigns 0, thereby configuring and outputting a pattern of the left window. Herein, the predetermined value may optionally be set according to the degree of noise and the result of simulation.

At this point, the at least one average value calculator 621 and census transformer 622 may be included on the respective left and right windows in order to enhance the process speed.

The hamming distance calculator 623 respectively compares the pattern of the left window with the pattern of the right window by bit to thereby calculate the hamming distance.

The adder 630 adds the output of the SAD processor 610, the output of the RMCT processor 620 and the calculated energy value of a node before a corresponding node stored in a memory (not shown) by an accumulated value of an appropriate rate, to thereby calculate the energy value U(i, j) of the corresponding node.

In the image matching apparatus, the multi-processing unit 420 further includes a memory (now shown) having a storage space equal to a value of the maximum disparity multiplied by the maximum site value in order to store a calculated energy value. The memory stores the storage space of an energy value and a direction value representing that an energy value is transferred from any node of the above and below nodes of a preceding site.

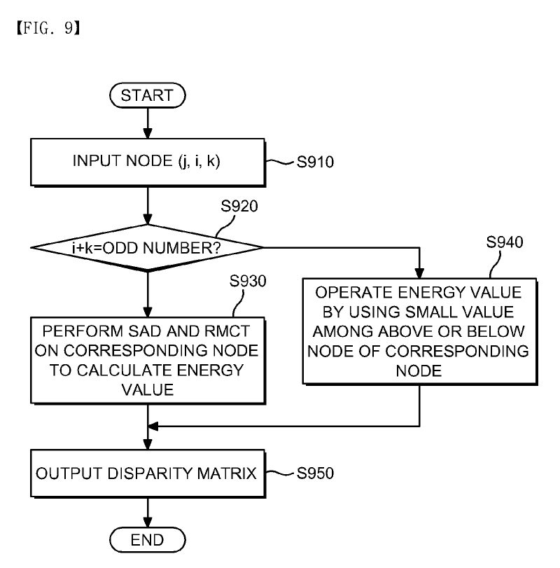

The following description will be made on a process where the image matching apparatus matches the stereo image of a frame with reference to FIG. 9. FIG. 9 is a flow chart illustrating an image matching method according to an embodiment of the present invention.

First, the image matching apparatus receives a left image composed of the node (j, i, k) and peripheral pixels surrounding the node (j, i, k) of a left image and a right image composed of the node (j, i, k) and peripheral pixels surrounding the node (j, i, k) of a right image in step S910. Herein, j is an order of a line axis, i is an order of a site axis, and k is an order of a disparity axis.

Subsequently, the image matching apparatus determines whether the node (j, i, k) of the left image and the node (j, i, k) of the right image are a matchable region in step S920. In step S920, the image matching apparatus adds i and k of the node (j, i, k), and determines the node (j, i, k) as the matchable region when the addition value of i and k is an odd number. When the addition value of i and k is an even number, the image matching apparatus determines the node (j, i, k) as an unmatchable region.

At this point, as described above, when the node (j, i, k) is the matchable region, the image matching apparatus adds the output of the SAD processor 610, the output of the RMCT processor 620 and the accumulated value of the energy value of a node before the node (j, i, k) stored in the memory (not shown), thereby calculating the energy value of the node (j, i, k) in step S930.

Alternatively, when the node (j, i, k) is the unmatchable region, the image matching apparatus selects a small value among the energy value of a node (j, i−1, k+1) being the above node of a node (j, i−1, k) and the energy value of a node (j, i−1, k−1) being the below node of the node (j, i−1, k), receives the matching value of a node (j, i−1, k+1) being the above node and the matching value of a node (j, i−1, k−1) being the below node, and performs a certain operation on them to thereby calculate the energy value of the node (j, i, k) in step S950.

Subsequently, the image matching apparatus configures and outputs a disparity value matrix for a stereo image by line using the direction value of the calculated energy value in step S940. The steps S910 to S950 are repeatedly operated on each line to thereby output the result of a frame, which is repeated by frame unit.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. An image matching apparatus, comprising:
a determining unit determining whether a node, in which a first pixel of a left image of a subject and a second pixel of a right image of the subject corresponding to the first pixel are calculated, is a matchable region; and
an operating unit calculating a disparity value by using the brightness information of a left window composed of the first pixel corresponding to the node and peripheral pixels surrounding the first pixel and the brightness information of a right window composed of the second pixel corresponding to the node and peripheral pixels surrounding the second pixel, when the node is the matchable region as a result of the determination.

2. The image matching apparatus of claim 1, wherein the operating unit calculates the disparity value by using the pixels peripheral to the first pixel and the pixels peripheral to the second pixel, when the node is an unmatchable region as a result of the determination.

3. The image matching apparatus of claim 2, wherein the operating unit comprises:
a first operator performing Sum of Absolute Difference (SAD) and Received Mean Census Transform (RMCT) on the left and right windows to calculate an energy value of a corresponding node corresponding to the first or second pixel in an synthesis image of the left and right images;
a second operator calculating an energy value of the corresponding node by using energy values of above and below nodes of the first pixel and energy values of above and below nodes of the second pixel; and
a third operator calculating the disparity value by using the energy value of the corresponding node.

4. The image matching apparatus of claim 3, wherein the first operator comprises:
a SAD processor performing SAD on the brightness information of the left and right windows;
a RMCT processor calculating average values of the brightness information of the left and right windows, performing Census Transform (CT) on the calculated average values, and outputting a hamming distance of the performed value; and
an adder adding an output of the SAD processor and an output of the RMCT processor,
wherein the first operator adds an output of the adder and an accumulated value of calculated energy values of nodes before the corresponding node.

5. The image matching apparatus of claim 4, further comprising a memory storing the accumulated value.

6. The image matching apparatus of claim 4, wherein the SAD processor comprises:
at least one of subtractor performing a subtraction operation on brightness information of respective nodes of the left window and brightness information of respective nodes of the right window corresponding to the respective nodes of the left window;
an absolute operator calculating absolute values of the respective subtraction results; and
at least one adder adding all the absolute values.

7. The image matching apparatus of claim 4, wherein the RMCT processor comprises:
at least one average value calculator outputting the average value of the brightness information of the left window and the average value of the brightness information of the right window;
a census transformer performing CT on the respective average values; and
a hamming distance operator comparing the CT results by bit to calculate a hamming distance.

8. The image matching apparatus of claim 3, wherein the second operator comprises a comparator comparing the energy value of the above node of the corresponding node with the energy value of the below node of the corresponding node to output a small value among the energy values.

9. An image matching apparatus, comprising:
a unit processing unit performing Sum of Absolute Difference (SAD) and Received Mean Census Transform (RMCT) on brightness information of left and right images to calculate an energy value of each node in an synthesis image of the left and right images;
a multi-processing unit calculating a matching value of a stereo image per each line by using the energy value of the each node; and
a rear processing unit calculating a disparity value of the stereo image by using the matching value.

10. The image matching apparatus of claim 9, wherein the unit processing unit accumulates a calculated energy value of a preceding node to the SAD and RMCT result per the each node to calculate the energy value of the each node.

11. The image matching apparatus of claim 9, wherein the unit processing unit performs SAD and RMCT on a left window composed of a first pixel of the left image corresponding to the each node and peripheral pixels surrounding the first pixel and a right window composed of a second pixel of the right image corresponding to the each node and peripheral pixels surrounding the second pixel to calculate the energy value of the each node.

12. The image matching apparatus of claim 9, wherein the unit processing unit calculates the energy value of the each node by using the SAD and RMCT result performed on the brightness information of the each node when the each node is a matchable region, and calculates the energy value of the each node by using a small value among energy values of above and below nodes of the each node when the each node is an unmatchable region.

13. The image matching apparatus of claim 12, wherein the above node and the below node are arranged about a disparity axis of the each node.

14. An image matching method, comprising:
determining whether a corresponding node, in which a first pixel of a left image of a subject and a second pixel of a right image of the subject corresponding to the first pixel are calculated, is a matchable region; and
calculating an energy value of the corresponding node by using the brightness information of a left window composed of the first pixel corresponding to a node and peripheral pixels surrounding the first pixel and the brightness information of a right window composed of the second pixel corresponding to the node and peripheral pixels surrounding the second pixel, when the first and second pixels are the matchable region as a result of the determination.

15. The image matching method of claim 14, further comprising calculating the energy value of the corresponding node by using energy values of pixels peripheral to the first and second pixels, when the first and second pixels are the unmatchable region as a result of the determination.

16. The image matching method of claim 15, wherein the determining of the matchable region comprises checking whether a sum of an order of a site axis of the first or second pixel and an order of a disparity axis of the first or second pixel is an odd or even number to determine the matchable region or the unmatchable region.

17. The image matching method of claim 14, wherein the calculating of the energy value comprises:
performing Sum of Absolute Difference (SAD) and Received Mean Census Transform (RMCT) on the left and right windows to calculate an energy value of a corresponding node corresponding to the first or second pixel in an synthesis image of the left and right images;
accumulating the calculated energy value of the corresponding node and energy values of nodes before the corresponding node to calculate a disparity value; and
configuring a matrix of the disparity value by line unit on the synthesis image.

18. The image matching method of claim 17, further comprising accumulating the energy values of the nodes before the corresponding node.

19. The image matching method of claim 17, wherein the calculating of the energy values comprises:
configuring the left window for the first pixel and the right window for the second pixel;
calculating absolute values of brightness information differences of the left and right windows by pixel unit, and adding the absolute values;
performing CT on an average value of brightness information of each pixel of the left and right windows to calculate a hamming distance; and
adding the added result and the calculated hamming distance to calculate an energy value of the corresponding node.
